(19) United States
(12) Patent Application Publication
(10) Pub. No.: US 2005/0242548 A1
(43) Pub. Date: Nov. 3, 2005

(54) Easy folding stroller

(76) Inventors: James M. F. Hutchinson, Mohnton, PA (US); Adam Bearup, Shillington, PA (US)

Correspondence Address: Martin Fruitman, 419 N. George St., Millersville, PA, 17551, US

(21) Appl. No.: 11/108,535

(22) Filed: Apr. 18, 2005

Related U.S. Application Data
(60) Provisional application No. 60/567,088, filed on Apr. 30, 2004.

(51) Int. Cl. B62B 1/00

(52) U.S. Cl. 280/642

(57) ABSTRACT

The apparatus is a baby stroller that folds easily. A fold bar preventing the sides from moving toward each other is released by pulling a flexible wire. The wire releases a latch locking together pivoting sections of the fold bar and also activates a cam to move the sections over center to permit the sides to be pushed together. The stroller also includes a single action brake system that is designed to not interfere with the folding action and a hard surface footrest that folds because it is supported on a continuous length of flexible material that acts as hinges on both sides and the center of the footrest.

This application is based upon provisional patent application Ser. No. 60/567,088 filed Apr. 30, 2004.

### BACKGROUND OF THE INVENTION

The invention deals generally with folding baby strollers and more specifically with a folding baby stroller for which folding is initiated more easily, that has a height adjustable canopy, and that affords a simpler single action brake mechanism.

Prior art folding strollers typically utilize an over-center fold bar link for the folding action which brings the two sides together. For releasing such a structure to initiate the folding sequence, this requires pulling up the center of the fold bar with the top of the foot or reaching down and pulling up on the bar with the hand.

For strollers that fold the sides toward each other it is also necessary to fold the footrest positioned between the sides across the front of the stroller. Prior art strollers have enabled the folding of the footrest by simply using thin flexible sheet material for the footrest so that the thin sheet collapses as the two sides come together. However, this type of footrest does not furnish satisfactory support or at least does not provide the sense of substantial support.

Another aspect of strollers currently available that needs improvement is the brake system. Typically, in order to apply braking to both sides of the stroller, it requires either a metal linkage across the rear near the bottom of the stroller, or two hand operated levers. The metal linkage resembles a bar between the rear wheels and interferes substantially with storage space under the stroller and the foot room of the person walking behind the stroller, while the twin lever design adds complexity and requires considerable hand strength to operate.

It would be very beneficial to have a stroller in which side to side folding could be initiated by a simple hand action that does not require reaching down to the wheel level, in which the footrest is rigid but automatically folds, and in which the brakes on both rear wheels can be operated by simple single action.

### SUMMARY OF THE INVENTION

The present invention uses a conveniently located hand release lever to pull a flexible wire that unlocks a latch between two sections of a fold bar that pivot on each other. The action of the flexible wire also operates a cam that pivots the two sections of the fold bar over center, so that the fold bar will not resist pushing the two sides of the stroller toward each other. During the unfolding of the stroller, sloping surfaces on the latch mechanism permit the latch to lock automatically without operation of the hand release. The route of the flexible wire is selected so that the wire also maintains a constant length.

The folding footrest of the preferred embodiment of the invention is essentially a rigid footrest divided into two sections that are hinged together and attached to the stroller sides with hinges. Thus when the stroller is folded the footrest automatically folds at its center hinge but when the stroller is unfolded the footrest furnishes rigid support. In the preferred embodiment, the hinges are constructed of thin flexible sheet material, and one continuous sheet is hung between the sides of the stroller to act as all three hinges. The thin sheet hinge structure yields significant economic benefit.

The brake apparatus of the preferred embodiment of the invention uses a single foot operated control button to activate the brakes on both rear wheels by interconnecting the two brake assemblies with a single flexible wire that is routed to loop high above the wheels so it accommodates the folding of the stroller. In the preferred embodiment, the control button is located on the right side of the person walking behind the stroller, but the choice of sides is not material to the operation. The brakes are unlocked when the control button is depressed and locked when the control button is up, and the button assembly is constructed so the control button remains in the position into which it is placed. With each push on the button it changes its condition so that the brakes are alternately placed off and on by pushing the control button.

The basic braking action is performed by a brake pin in each brake assembly that moves toward its wheel and into an interlocking position with braking devices such as holes, spokes, or slots on the wheel. A moving wedge in each brake assembly pushes the pin inward toward the center of the stroller to the unlocked position, and a spring moves the pin toward the wheel and into the locked position when the wedge releases the pin.

Another feature of the stroller of the preferred embodiment is a cup holder that folds flat against any part of a stroller to which it is attached so that it is out of the way when the stroller is folded. When closed, the cup holder looks somewhat like a large pill box. When folded, a ring to encircle a cup is held flat against a mounting bracket attached to the stroller, and a fixture at the lower end of the ring interlocks with and slides within a vertical slot in the mounting bracket. A yoke which is concentric with the ring is attached by a hinge located above the slot, swings away from the mounting bracket, and is also pivotally attached to the sides of the ring. Thus, to open the cup holder, the ring is slid upward in the slot, and the yoke swings outward to support the ring and form a right angle between the ring and the mounting bracket.

The bottom of the cup holder can be formed by either of two structures. One structure is a hinged bottom support attached below the slot at the lower end of the mounting bracket. Such a structure also acts as a cover for the folded cup holder. The yoke, the ring, and the bottom can be made concentric, and the bottom includes a latch so that when the cup holder is folded the latch locks it closed. When folded the thickness of the assembly is virtually the same as the thickness of the ring.

The other bottom structure is a flat bottom cylinder with sides of flexible material such as net. The cylinder is hung from the ring which forms the top of the cylinder. When the flat bottom is flexible material or a hard circular disc that is smaller than the ring, the bottom and flexible material can simply be pushed into the ring for folding the cup holder.

The stroller of the preferred embodiment also includes a height adjustable canopy which facilitates folding because it permits lowering the canopy so that it does not protrude from the rest of the stroller when the stroller is folded. Both the front and back canopy support loops terminate at the same holding fixtures mounted on the handle lower support tubes on both sides of the stroller, and the loops bend so that their opposite ends easily move toward each other when the stroller is folded. The holding fixtures slide on tracks on the handle support tubes, and detents that are released by hand action keep the holding fixtures in position. Unlike prior art canopies that typically have the rear of the canopy permanently attached near the handle, the present invention permits the entire canopy to be moved up and down the handle support tubes.

The present invention thereby furnishes a stroller that is easily released to fold the sides together and includes a folding footrest, a height adjustable canopy, a folding cup holder, and a single action two wheel brake mechanism, all of which facilitate the side to side folding action.

### BRIEF DESCRIPTION OF THE DRAWINGS

FIG. 1 is a perspective view of the framework of the stroller of the preferred embodiment of the invention.

FIG. 2 is an enlarged view of the rear lower portion of the stroller frame showing the locations of the one hand release fold bar and the single action brake control button.

FIG. 3 is a schematic view of the rear “X” frame to which the fold bar is attached and the fold bar when the stroller is open and the latch is locked and uncovered.

FIG. 4 is an enlarged schematic view of the region of FIG. 3 immediately adjacent to the latch, showing the latch uncovered, unlocked, and released for folding.

FIG. 5 is a cut-away view of the brake control assembly.

FIG. 6 is a schematic view of the slave brake assembly with its inboard cover removed.

FIG. 7 is a schematic view of the folding footrest as it is partially folded.

FIG. 8 is a perspective view of the folding cup holder when it is open.

FIG. 9 is an enlarged view of the region of one of the height adjustable canopy holding assemblies where it is mounted on a handle support tube.

### DETAILED DESCRIPTION OF THE INVENTION

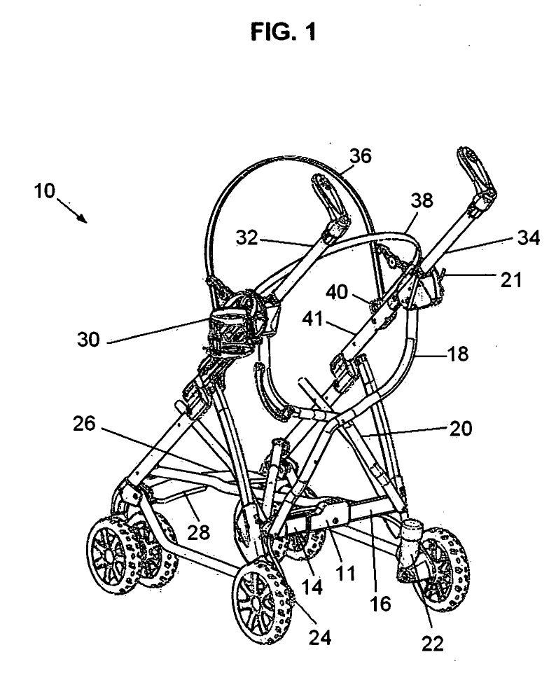

FIG. 1 is a rear perspective view of frame 10 of the stroller of the preferred embodiment of the invention showing the location of the important features of the invention. Front, rear, right, and left designations as used in the following text are referenced to the orientation of both a child sitting in the stroller and an adult pushing the stroller.

Fold bar latch assembly 11 is located between fold bar left section 14 and fold bar right section 16 at the rear of the frame near the bottom of rear “X” frame members 18 and 20. Fold bar control handle 21 is shown mounted on right handle support tube 34. Brake control assembly 22 is located inboard from the right rear wheel, and brake slave assembly 24 is barely visible inboard from the left rear wheel. Both footrest sections, 26 and 28, are visible toward the front of frame 10, and folding cup holder 30 is shown attached to left handle support tube 32. Canopy loops 36 and 38 that are usually covered by fabric are both attached to holding assemblies 40 (only one of which is visible in FIG. 1) that slide upon tracks 41 attached to handle support tubes 32 and 34. Each of these features is discussed separately in the following text and shown in the associated figures.

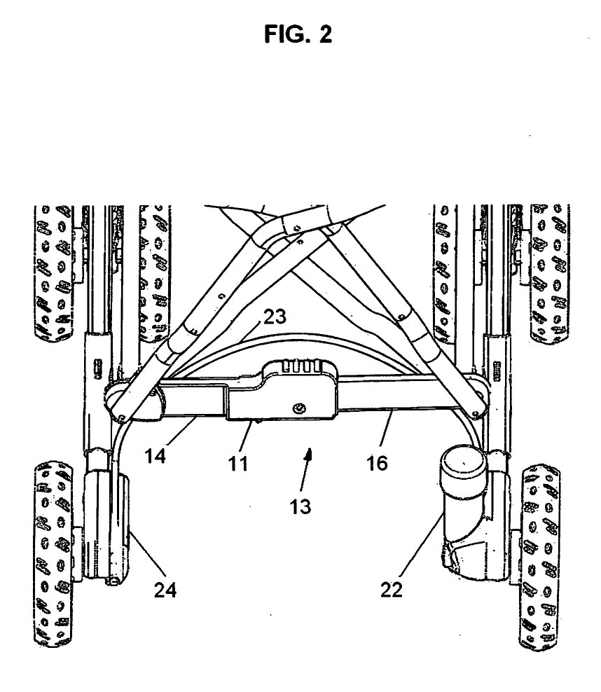

FIG. 2 is an enlarged view of the rear lower portion of stroller frame 10 more clearly showing hand release fold bar 13 and its component parts, single action brake control assembly 22, brake slave assembly 24, and brake connecting cable 23. The details of the structures and operation of these parts are described in the following text and figures.

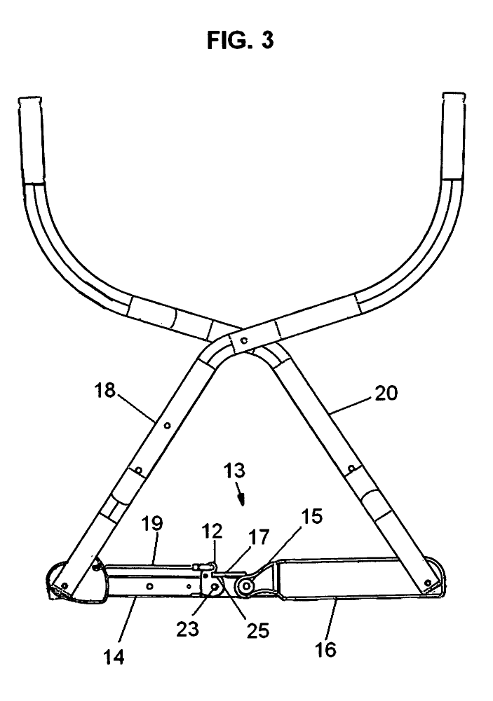

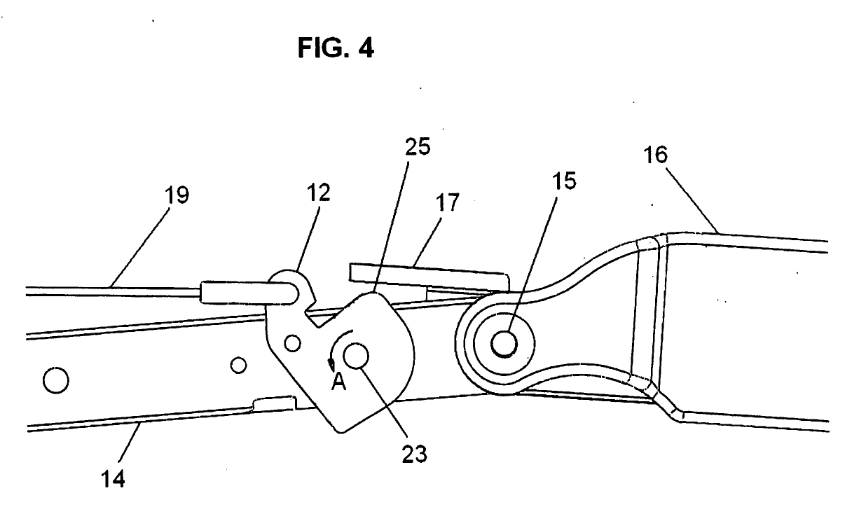

FIG. 3 is a schematic view of fold bar 13 and rear “X” frame members 18 and 20 to which fold bar 13 is attached, with the stroller shown open and latch 12 locked and uncovered. FIG. 4 is a larger view of the region immediately adjacent to latch 12 showing latch 12 unlocked with catch bar 17 released and bar pivot 15 having moved slightly above its latched position. Fold bar left section 14 and fold bar right section 16 are connected by and rotate relative to each other upon bar pivot 15 when latch 12 permits folding. As can be seen in FIGS. 3 and 4, during the unfolding operation, catch bar 17 will hit the top of latch 12 and move down the slope of latch 12 until catch bar 17 locks within latch 12.

Latch 12 is controlled by cable 19 that terminates at fold bar control handle 21 (see FIG. 1) where cable 19 can be activated by the stroller user to move latch 12 counterclockwise in the direction indicated by arrow A. An important action of latch 12 is that as it pivots on latch pivot 23 latch corner 25 moves against catch bar 17 and pushes fold pivot 15 and fold bar right section 16 upward and over center. Thus, the folding of fold bar 13 has proceeded far enough to permit completion of the folding action by merely pushing the two sides of stroller frame 10 together.

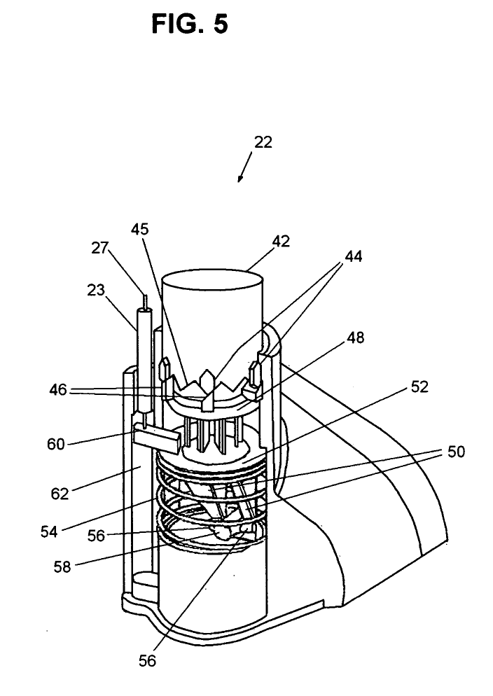

FIG. 5 is a cut-away view of brake control assembly 22. Brake control assembly 22 is operated by control button 42 which is to be operated by the foot of the person pushing the stroller. Teeth 44 and 45 on the bottom of control button 42 mate with teeth 45 and 46 on rotating gear 48 inside of and concentric with control button 42 and the teeth produce a rotating motion within brake control assembly 22 while producing an alternating lowering and raising of wedge assembly 52 and split wedges 50. As wedges 50 move up due to the force from compression wedge spring 54, they permit ears 56 and brake pin 58 to move outward toward its wheel due to the action of a brake pin compression spring (not shown) internal to brake control assembly. When brake pin 58 moves out toward its wheel, it mates with the braking devices on the wheel and provides a positive lock against wheel rotation. When control button 42 moves into its lowered position, wedges 50 move down and act on ears 56 to move brake pin 58 out of its mating position with the braking devices of its wheel, and the wheel is free to rotate.

Brake control assembly 22 also controls the action of slave brake assembly 24 (see FIG. 1) on the opposite side of stroller frame 10. This action is accomplished by the use of flexible cable 23 that is also shown in FIG. 1. As shown in FIG. 5, center wire 27 of flexible cable 23 is connected to arm 60 which is itself attached to and moves up and down with wedge assembly 52. Arm 60 moves within and is guided by slot 62 within the housing of brake control assembly 22. Thus, when wedge assembly 52 moves down to unlock the brake on its wheel it also pulls center wire 27 of cable 23, and when wedge assembly 52 moves up it pushes center wire 27 of cable 23.

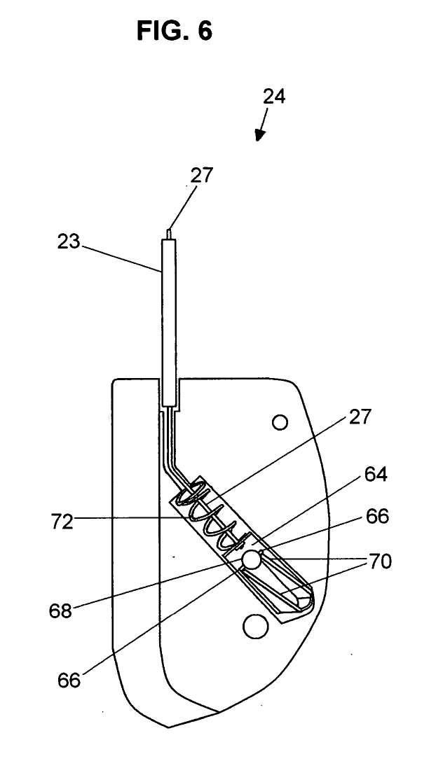

FIG. 6 is a schematic view of slave brake assembly 24 with its inboard cover removed for viewing the internal construction. The action of slave brake assembly 24 is similar to that of brake control assembly previously discussed in that as wedge assembly 64 moves up and down it moves ears 66 and brake pin 68 in and out of contact with its braking devices by the action of wedges 70. Also similar to the action in control brake assembly 22 of FIG. 5, compression wedge spring 72 drives wedge assembly 64 down and a compression spring (not shown) moves brake pin 68 outward into contact with its wheel.

The essential difference of slave brake assembly 24 from brake control assembly 22 is that the actions of the wedges are reversed. Because center wire 27 of cable 23 is pulled by brake control assembly 22 as control button 42 is pushed and brake control assembly 22 pulls its pin out of contact with the wheel, wedges 70 of slave brake assembly 24 must also move to extract brake pin 68 from its wheel upon the same motion. However, as control brake assembly 22 unlocks its wheel upon the pushing action on foot operated button 42, slave brake assembly 24 must unlock its wheel upon the pulling action wire 27. The reversed wedges accomplish this accommodation from a pushing to a pulling motion, and are the key to the ability to use a simple single control to operate brakes on both sides of the stroller.

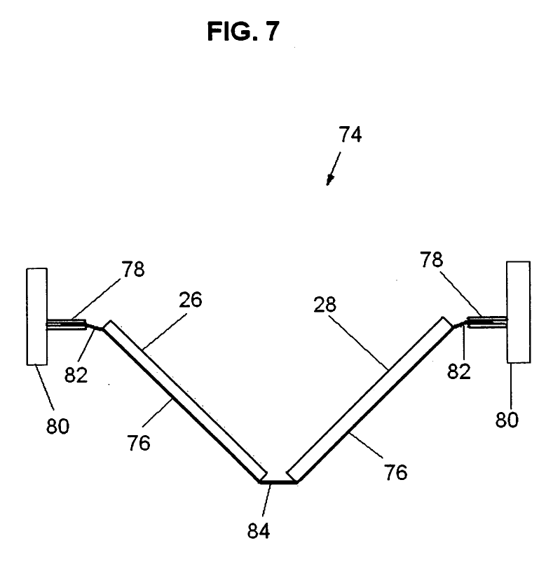

FIG. 7 is a schematic view of folding footrest 74 as it is partially folded. Footrest sections 26 and 28 are supported by thin flexible sheet 76 which is attached to and stretched between the opposite sides of the stroller when the stroller is open. The ends of sheet 76 are held within retainers 78 that are attached at the front end of handle support tubes 32 and 34 (see FIG. 1) by clamp fixtures 80. Footrest sections 26 and 28 are constructed of rigid material and attached to sheet 76 so that foot rest 74 actually feels and acts like a rigid platform when flexible sheet 76 is stretched taunt as shown in FIG. 1. However, when the stroller sides are moved toward each other, sheet 76 acts as if it were three separate hinges holding footrest sections 26 and 28. At side locations 82 the footrest sections can fold down, and at center location 84 footrest sections 26 and 28 can fold toward each other. Footrest 74 thereby yields the economy of inexpensive materials and simple installation while offering the benefits of both a folding and a rigid footrest.

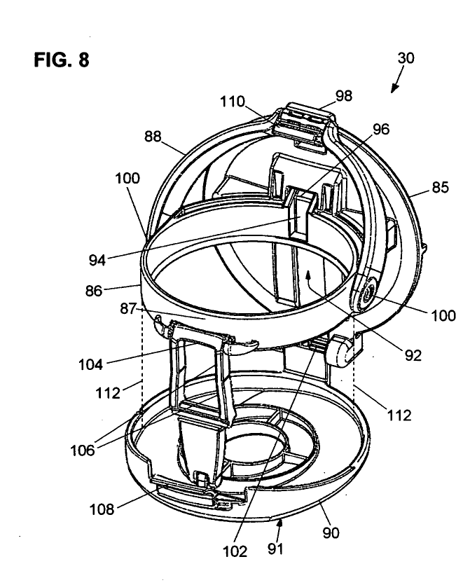

FIG. 8 is a perspective view of folding cup holder 30 when it is open. The four basic parts of cup holder 30 are mounting plate 85, ring 86, yoke 88, and bottom support 90. Mounting plate 85 includes vertical slot 92 within which ring sliding fixture 94 interlocks and slides. Ring sliding fixture 94 includes pivot 96 that holds ring 86 and permits ring 86 to move between its horizontal position shown and a vertical position parallel to the orientation of mounting plate 85. Yoke 88 is attached to mounting plate 85 at pivot 98 and to ring 86 at diametrically opposite locations at pivots 100.

Thus, starting from the position shown in FIG. 8, as ring sliding fixture 94 is moved downward within slot 92, outboard side 87 of ring 86 swings up and inward to store ring 86 flush against mounting plate 85 and within yoke 88 which is also flush against mounting plate 85.

Bottom support 90 is also constructed to fold up parallel to mounting plate 85, and also to provide a cover for ring 86 and its related components. Bottom support 90 has a solid underside surface 91 and bottom support 90 is suspended from mounting plate 85 by rear pivot 102 and from outboard side 87 of ring 86 by pivot bar 104 and folding links 106. Therefore, as outboard side 87 of ring 86 swings upward, bottom support 90 follows along. When the movement is complete, latch 108 on bottom support 90 meets and interlocks with catch 110 at the upper point of yoke 88, and bottom support 90 remains in that position to cover the internal parts of cup holder 30 until latch 108 is intentionally released. It should be appreciated that a cylinder of flexible material, represented by dashed lines 112, can also be used to suspend bottom support 90 instead of rear pivot 102 and folding links 106. With either suspension structure, cup holder 30 can be folded so that it is out of the way when the stroller is folded.

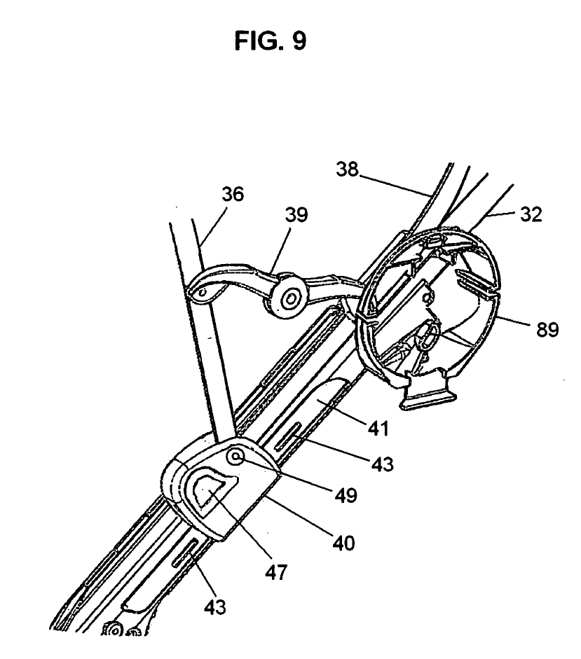

FIG. 9 is an enlarged view of the region of one of the height adjustable canopy holding assemblies 40 where it is mounted on handle support tube 32. Canopy holding assembly 40 interlocks with and slides upon canopy track 41, one of which is also seen in FIG. 1, which is constructed with an inverted “U” cross section, and is attached to handle support tube 32. Canopy track 41 includes a series of slots 43 that function as locating detents for canopy holding assembly 40, so that it can be locked at various heights along track 41. Canopy holding assembly 40 includes release button 47 and a simple spring loaded locking mechanism (not shown) so that release button 47 unlocks canopy holding assembly 40 from whichever slot 43 it is interlocked with, and the locking mechanism locks canopy holding assembly 40 into a slot if release button 47 is not being depressed.

The quite conventional arrangement for folding canopy loops 36 and 38 together can also be seen in FIG. 9. They are interconnected by folding link 39 which only needs to be folded at its center pivot to permit the canopy loops to swing toward each other. However, it should be appreciated that an important aspect of the invention is that the bottoms of canopy loops 36 and 38 are both attached to canopy holding assembly 40 at canopy loop pivot point 49. The height adjustment function of the canopy depends upon the fact that both loops 36 and 38 are attached to and simultaneously move with canopy holding assembly 40, so that the present invention provides a convenient arrangement for lowering a stroller canopy for minimizing the folded length of the stroller.

Another component of the present invention shown in FIG. 9 is cup mounting fixture 89 that is also attached to handle support tube 32. Cup mounting fixture 89, which can easily be attached to either the right or left handle support tube, is constructed to mate with and hold cup mounting plate 85 of FIG. 8.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

1. A foldable stroller comprising:
a frame with a first side and a second side, with each side having at least one front wheel and at least one rear wheel;
a fold bar comprising a first section and a second section with the sections attached together at a common pivot point, the first section of the fold bar attached to the first side of the frame at a first pivot point, and the second section of the fold bar attached to the second side of the frame at a second pivot point;
a latch assembly attached to the fold bar adjacent to the common pivot point, with the latch assembly comprising;
a latch which, when latched, prevents the first section and the second section of the fold bar from moving relative to each other;
a latch release which, when activated, releases the latch and permits the first section and the second section of the fold bar to pivot relative to each other; and
a motive device which, when activated, pivots the first section and the second section of the fold bar relative to each other and into an over center orientation to permit further pivoting of the first section and the second section of the fold bar relative to each.

2. The foldable stroller of claim 1 wherein the latch release and the motive means are interconnected and are activated together.

3. The foldable stroller of claim 1 further including a remote activation device attached to the latch release and capable of activating the latch release from a remote location.

4. The foldable stroller of claim 1 further including a flexible wire attached to the latch release and capable of activating the latch release from a remote location.

5. The foldable stroller of claim 1 wherein the latch release and the motive device are interconnected and activated together, and further including a remote activation device attached to the latch release and capable of activating the latch release and the motive device from a remote location.

6. The foldable stroller of claim 1 wherein the latch release and the motive device are interconnected and activated together, and further including a flexible wire attached to the latch release and capable of activating the latch release and the motive device from a remote location.

7. The foldable stroller of claim 1 wherein the motive device is a rotating cam.

8. A foldable stroller comprising:
a frame with a first side and a second side, with each side having at least one front wheel and at least one rear wheel;
a folding footrest comprising a first section and a second section attached to each other by a hinge, with the first section of the footrest attached to the first side of the frame by a hinge, and the second section of the footrest attached to the second side of the frame by a hinge; and
the two sections of the footrest are constructed with top surfaces of rigid materials.

9. The foldable stroller of claim 8 wherein the hinges are flexible material.

10. The foldable stroller of claim 8 wherein the all hinges are parts of one continuous piece of flexible material.

11. A folding cup holder for attachment to a stroller comprising:
a mounting plate for attachment to a stroller with the mounting plate including a vertical slot;
a ring to encircle a cup, with a ring sliding fixture attached to the outside of the ring, and the ring sliding fixture inserted into and sliding within the vertical slot and with the ring sliding fixture including a device that holds the ring sliding fixture within the slot;
a semicircular yoke concentric with the ring, attached to opposite sides of the ring with pivots, and with the yoke's midpoint attached to the mounting plate by a pivot at a location above the slot; and
a bottom support attached to the mounting plate by a pivot at a location below the slot.

12. The folding cup holder of claim 11 wherein the bottom support is circular and fits within the ring.

13. The folding cup holder of claim 11 further including
a cylinder of flexible material with a closed bottom attached to and hanging below the ring to support a cup.

14. A foldable stroller comprising:
a frame with a first side and a second side, with each side having at least one front wheel and at least one rear wheel;
two handle tubes, one attached to each side of the frame;
a front flexible loop and a rear flexible loop between which a canopy of flexible material can be suspended, with each loop connected to and spanning between the two handle tubes, with the connections of the two loops to each handle being on a common holding assembly, and with each holding assembly interconnected with the handle tube and releasable to slide on the handle tube.

15. The foldable stroller of claim 14 further including at least two detents on each handle tube to determine specific locations at which the holding assembly can lock into position.

16. A foldable stroller comprising:
a frame with a first side and a second side, with each side having at least one rear wheel;
a first brake assembly attached to the first side of the frame at a location adjacent to at least one rear wheel, the first brake assembly comprising:
braking devices on the rear wheel located on the inboard side of the wheel;
a first pin held within the first brake assembly, with the first pin movable in and out of a position within any one of the braking devices that prevents the rear wheel from rotating;
a button located on the first brake assembly and operable with foot action, with the button having a first and a second position and interconnected to the first pin so that placing the button in the first position allows the first pin to move into the braking devices, and placing the button in the second position allows the first pin to move out of the braking devices;
a second brake assembly attached to the second side of the frame at a location adjacent to at least one rear wheel, the second brake assembly comprising:
braking devices on the rear wheel located on the inboard side of the wheel;
a second pin held within the second brake assembly, with the second pin movable in and out of a position within any one of the braking devices that prevents the rear wheel from rotating;
a pin mover attached to the second brake assembly, with the pin mover interconnected to the second pin so that operating the pin mover allows the second pin to move in and out of the braking devices; and
a flexible wire interconnecting the button in the first brake assembly to the pin mover in the second brake assembly so that operating the button in the first brake assembly operates the pin mover in the second brake assembly in a manner to duplicate the action of the first pin with the second pin.

17. The foldable stroller of claim 16 further including a button control device interconnected with the button and holding the button in whichever position it is placed.

18. The foldable stroller of claim 16 wherein the first pin has protrusions, a moving wedge contacts the protrusions to move the first pin, and the wedge is interconnected to and moved by the button.

19. The foldable stroller of claim 16 wherein the second pin has protrusions, a moving wedge contacts the protrusions to move the second pin, and the wedge is interconnected to and moved by a wire interconnecting the button in the first brake assembly to the pin mover in the second brake assembly so that operating the button in the first brake assembly operates the pin mover in the second brake assembly in a manner to duplicate the action of the first pin with the second pin.
